(19) United States
(12) Patent Application Publication
(10) Pub. No.: US 2014/0362491 A1
(43) Pub. Date: Dec. 11, 2014

(54) CERAMIC ELECTRONIC COMPONENT AND MANUFACTURING METHOD THEREFOR

(71) Applicant: MURATA MANUFACTURING CO., LTD., Nagaokakyo-Shi (JP)

(72) Inventors: Hiroshige Adachi, Nagaokakyo-shi (JP); Kazuhiro Kaneko, Nagaokakyo-shi (JP); Yuki Takemori, Kyoto-Fu (JP)

(73) Assignee: MURATA MANUFACTURING CO., LTD., Nagaokakyo-Shi (JP)

(21) Appl. No.: 14/282,057

(22) Filed: May 20, 2014

(30) Foreign Application Priority Data
Jun. 5, 2013 (JP) 2013-118434

(51) Int. Cl. H01G 4/12; H01G 4/40; H01F 27/40; C04B 35/64

(52) U.S. Cl. CPC H01G 4/1209; C04B 35/64; H01G 4/40; H01F 27/40
USPC 361/270; 264/611

(57) ABSTRACT

When firing a composite substrate structured to have stacked ceramic dielectric and ceramic magnetic layers, a glass constituent is diffused from the ceramic dielectric layer to the ceramic magnetic layer to, as a result, decrease sinterability of the ceramic dielectric layer or degrade insulation resistance characteristics thereof. When the ceramic dielectric includes 40 to 80% by weight of glass formed from 35 to 50% by weight of CaO, 0 to 20% by weight of Al₂O₃, 5 to 20% by weight of B₂O₃, and 30 to 50% by weight of SiO₂; and 20 to 60% by weight of at least of alumina, forsterite, and/or quartz, this problem is avoided. The dielectric composition increases the viscosity of the glass, and suppresses constituent diffusion from the ceramic dielectric layer to the ceramic magnetic layer, because the glass is partially crystallized to form wollastonite during firing.

### TECHNICAL FIELD

This invention relates to a ceramic electronic component and a manufacturing method therefor, and in particular, relates to a ceramic electronic component including a composite substrate structured to have a ceramic dielectric layer and a ceramic magnetic layer stacked, and a manufacturing method therefor.

### BACKGROUND ART

Techniques of interest to this invention include, for example, the technique described in Japanese Unexamined Patent Publication No. H1-61015 (Patent Document 1). Patent Document 1 describes a ceramic LC composite component obtained by integrating a capacitor unit that has stacked ceramic dielectric layers and electrode layers, and an inductor unit that has stacked ceramic magnetic layers and electrode layers stacked. More specifically, the ceramic dielectric layers contain a ceramic dielectric and borosilicate glass, the content rate of the borosilicate glass is 5 to 60% by weight, the borosilicate glass contains 75 to 90% by weight of silicon oxide and 8 to 20% by weight of boron oxide, and the difference in linear expansion coefficient is 10×10⁻⁷ deg⁻¹ or less between the ceramic dielectric layers and ceramic magnetic layers.

Patent Document 1 mentions that when the ceramic dielectric layers and the ceramic magnetic layers are subjected to co-sintering, the occurrence of cracking, peeling, and warpage resulted from the difference in linear expansion coefficient can be prevented by providing the above composition for the ceramic dielectric layers and setting the difference in linear expansion coefficient between the ceramic dielectric layers and the ceramic magnetic layers as mentioned above.

### PRIOR ART PATENT DOCUMENT

Patent Document 1: JP-A No. 1-61015

### SUMMARY OF THE INVENTION

### Problems to be Solved by the Invention

However, According to the description in Patent Document 1, the problem of interdiffusion between the ceramic dielectric layers and the ceramic magnetic layers, which can be caused during firing, is not avoided More specifically, the glass constituent is diffused from the ceramic dielectric layers to the ceramic magnetic layers because it is difficult to suppress interdiffusion which can be caused between the ceramic dielectric layers and ceramic magnetic layers, and as a result, problems such as decreased sinterability of the ceramic dielectric layers and degraded insulation resistance characteristics thereof have been encountered in some cases.

Therefore, an object of this invention is to provide a ceramic electronic component which can solve the problems as described above, and a manufacturing method therefor.

### Means for Solving the Problems

This invention is first directed to a ceramic electronic component including a composite substrate structured to have stacked a ceramic dielectric layers and ceramic magnetic layers, and in order to solve the technical problems described above,

the ceramic dielectric layer includes:

40 to 80% by weight of glass containing 35 to 50% by weight of CaO, 0 to 20% by weight of Al₂O₃, 5 to 20% by weight of B₂O₃, and 30 to 50% by weight of SiO₂;

20 to 60% by weight of at least one ceramic selected from the group of alumina, forsterite (Mg₂SiO₄), and quartz; and further

at least crystalline wollastonite (CaSiO₃).

The ceramic magnetic layer preferably contains Ni—Cu—Zn based ferrite. This allows the ceramic magnetic layer to achieve a high magnetic permeability, and thus, the ceramic component to achieve favorable characteristics.

This invention is also directed to a method for manufacturing the ceramic electronic component. The method for manufacturing the ceramic electronic component according to the present invention includes the steps of: preparing a dielectric ceramic green sheet and a magnetic ceramic green sheet, respectively; preparing a composite stacked body by stacking the dielectric ceramic green sheet and the magnetic ceramic green sheet; and obtaining a composite substrate by firing the composite stacked body.

Further, in order to solve the technical problems previously described, the step of preparing a dielectric ceramic green sheet includes a step of preparing a dielectric ceramic green sheet including: 40 to 80% by weight of glass containing 35 to 50% by weight of CaO, 0 to 20% by weight of Al₂O₃, 5 to 20% by weight of B₂O₃, and 30 to 50% by weight of SiO₂ as solid constituents; and 20 to 60% by weight of at least one ceramic selected from the group of alumina, forsterite, and quartz. When the composite stacked body which is obtained by stacking the dielectric ceramic green sheet of this composition and the magnetic ceramic green sheet is fired, the glass is partially crystallized to deposit at least wollastonite.

### Effects of the Invention

The ceramic dielectric layer or dielectric ceramic green sheet mentioned above has a composition in which the glass is partially crystallized to deposit at least wollastonite during firing. When the glass is partially crystallized, the viscosity of glass is increased.

Therefore, the viscosity of the glass is increased during firing according to this invention, and constituent diffusion can be thus suppressed from the dielectric ceramic green sheet to the magnetic ceramic green sheet, that is, from the ceramic dielectric layer to the ceramic magnetic layer. As a result, problems such as decreased sinterability of the ceramic dielectric layer and degraded insulation resistance characteristics thereof, and furthermore, problems such as degraded characteristics of the ceramic magnetic layer, are less likely to be caused.

### BRIEF DESCRIPTION OF THE DRAWINGS

FIG. 1 is a cross-sectional view illustrating a ceramic electronic component 1 according to an embodiment of this invention.

FIG. 2 is intended to illustrate a capacitor 11 including a substrate 12 structured to have only ceramic dielectric layers stacked, prepared in Experimental Example, FIG. (A) is a cross-sectional view illustrating a cut in the thickness direction of the substrate 12, FIG. (B) is a cross-sectional view along a plane with an internal electrode 13 passing, and FIG. (C) is a cross-sectional view along a plane with an internal electrode 14 passing.

FIG. 3 is intended to illustrate a capacitor 21 including a composite substrate 22 structured to have a ceramic dielectric layer 23 and a ceramic magnetic layer 24 stacked, prepared in Experimental Example, FIG. (A) is a cross-sectional view illustrating a cut in the thickness direction of the substrate 22, FIG. (B) is a cross-sectional view along a plane with an internal electrode 13 passing, and FIG. (C) is a cross-sectional view along a plane with an internal electrode 14 passing.

### CARRYING OUT THE INVENTION

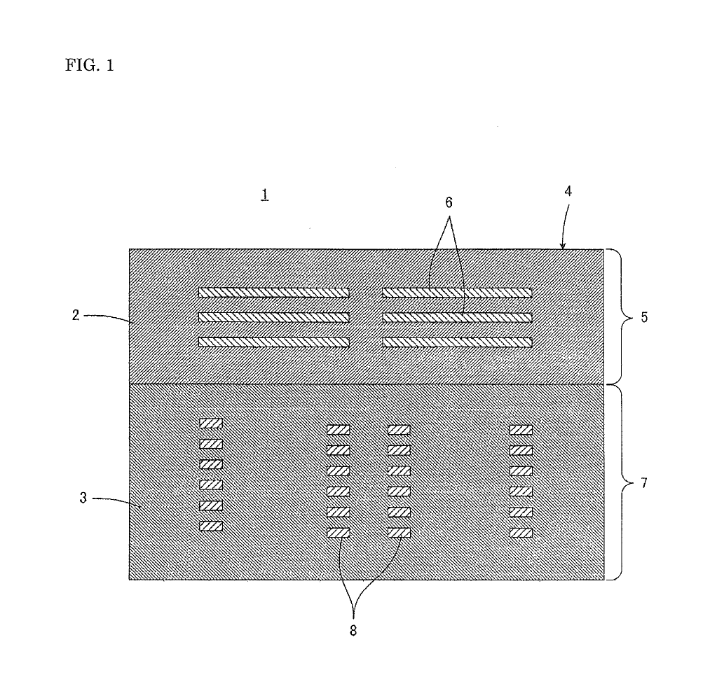

With reference to FIG. 1, a ceramic electronic component 1 according to an embodiment of this invention will be described.

The ceramic electronic component 1 includes a composite substrate 4 structured to have a stacked ceramic dielectric layer 2 and ceramic magnetic layer 3. The ceramic dielectric layer 2 and ceramic magnetic layer 3 are respectively illustrated as all-in-one in FIG. 1, but each can actually be a stacked structure composed of a plurality of stacked layers.

The ceramic dielectric layer 2 includes glass and ceramic as can be seen from a manufacturing method as will be described later, where the glass is derived from a glass containing 35 to 50% by weight of CaO, 0 to 20% by weight of Al₂O₃, 5 to 20% by weight of B₂O₃, and 30 to 50% by weight of SiO₂ as starting raw materials, whereas the ceramic has, as a starting raw material, at least one ceramic selected from the group of alumina, forsterite, and quartz. The ceramic dielectric layer 2 includes 40 to 80% by weight of the glass and 20 to 60% by weight of the ceramic at the stage of the starting raw materials. In addition, the ceramic dielectric layer 2 includes at least wollastonite as a crystalline material when fixed.

The ceramic magnetic layer 3 preferably contains a Ni—Cu—Zn based ferrite. The Ni—Cu—Zn based ferrite just described allows the ceramic magnetic layer 3 to achieve a high magnetic permeability, and thus, the ceramic component 1 to achieve favorable characteristics.

The section of the composite substrate 4, which is occupied by the ceramic dielectric layer 2 constitutes a capacitor section 5, which has therein a plurality of capacitor electrodes 6 opposed to each other. On the other hand, the section of the composite substrate 4 which is occupied by the ceramic magnetic layer 3, constitutes an inductor section 7, which is provided with coil conductors 8 extending in a coil shape therein.

In this way, the ceramic electronic component 1 shown in FIG. 1 constitutes an LC composite component.

Next, a preferred method for manufacturing the ceramic electronic component 1 will be described.

First, respectively prepared are dielectric ceramic green sheets to serve as the ceramic dielectric layer 2 and magnetic ceramic green sheets to serve as the ceramic magnetic layer 3.

The dielectric ceramic green sheet is obtained by forming a slurry into the shape of a sheet, where the slurry includes: 40 to 80% by weight of glass containing 35 to 50% by weight of CaO, 0 to 20% by weight of Al₂O₃, 5 to 20% by weight of B₂O₃, and 30 to 50% by weight of SiO₂ as solid constituents; 20 to 60% by weight of at least one ceramic selected from the group of alumina, forsterite, and quartz; and further a solvent, a binder, and a plasticizer.

On the other hand, the magnetic ceramic green sheet is obtained by forming a slurry into the shape of a sheet, where the slurry includes, for example, a calcined powder of Ni—Cu—Zn based ferrite, and includes a solvent, a binder, and a plasticizer. In place of the Ni—Cu—Zn based ferrite, Ni—Zn based ferrite or Mn—Zn based ferrite may be used.

On the dielectric ceramic green sheet, a conductive film to serve as the capacitor electrode 6 is formed by, for example, printing a conductive paste thereon. On the other hand, a conductive film to serve as the coil conductor 8 and, if necessary, a via conductor are formed by printing a conductive paste on the magnetic ceramic green sheet.

Next, a plurality of dielectric and magnetic green sheets are stacked and the resulting dielectric ceramic green sheet and the magnetic ceramic green sheet are stacked as required in a predetermined order. This provides a composite stacked body to serve as the composite substrate 4.

Next, the composite stacked body is subjected to firing at 1000° C. or lower, thereby providing the composite substrate 4. During this firing step, the glass included in the dielectric ceramic green sheet is partially crystallized to deposit at least wollastonite therein. When the glass is partially crystallized, the viscosity of glass is increased. Therefore, constituent diffusion from dielectric ceramic green sheet to the magnetic ceramic green sheet is suppressed, that is, from the ceramic dielectric layer 2 to the ceramic magnetic layer 3, and problems such as decreased sinterability of the ceramic dielectric layer 2, degraded insulation resistance characteristics thereof, and degraded characteristics of the ceramic magnetic layer 3 are not likely to be caused.

The ceramic dielectric layer 3 of the thus obtained composite substrate 4 maintains the elemental composition of the starting raw materials including 40 to 80% by weight of the glass containing 35 to 50% by weight of CaO, 0 to 20% by weight of Al₂O₃, 5 to 20% by weight of B₂O₃, and 30 to 50% by weight of SiO₂; and 20 to 60% by weight of at least one ceramic selected from the group of alumina, forsterite, and quartz. In addition, the ceramic dielectric layer 3 includes at least wollastonite as a crystalline material therein.

Next, on the outer surface of the composite substrate 4, external electrodes to serve as terminals and connecting conductors connected to the capacitor electrodes 6 and the coil conductors 8 are formed if necessary, thereby completing the ceramic electronic component 1 as an LC composite component.

While the ceramic electronic component 1 shown in FIG. 1 constitutes an LC composite component as just described, the ceramic electronic component according to this invention does not always have to be an LC composite component as long as the component includes the composite substrate structured to have the ceramic dielectric layer and ceramic magnetic layer stacked, but may be a ceramic electronic component including only a single functional element or may be used as a module mounted with other electronic components.

In addition, the respective numbers and stacking order of the ceramic dielectric layers and ceramic magnetic layers of the composite substrate included in the ceramic electronic component according to this invention can be arbitrarily changed depending on the function required for the ceramic electronic component.

### Experimental Example

The ceramic electronic component according to this invention will be more specifically described below with reference to an experimental example.

### (1) Preparation of Dielectric Ceramic Green Sheet:

Oxides or carbonates as starting raw materials were blended so as to provide the glass composition as shown in Table 1, put in a Pt crucible, and melted for 1 hour at a temperature of 1300 to 1500° C. depending on the glass composition. Next, the glass melt was quenched, and then subjected to grinding to obtain a glass powder.

As a ceramic powder filler, an alumina powder, a forsterite powder, and a quartz powder were |prepared|[M1], and these powders were weighed to achieve the ratios by weight as shown in Table 1.

Then, the glass powder and the ceramic powder were mixed in the proportions represented by the “Glass Content” and “Filler Content” in Table 1, and mixed with the addition of a solvent, a binder, and a plasticizer thereto, and a doctor blade method was applied thereto to form a slurry for obtaining dielectric ceramic green sheets according to each sample.

TABLE 1

| | Glass | | | | | Filler | | | |
|---|---|---|---|---|---|---|---|---|---|
| | Composition | | | | Glass | | | | Filler |
| Sample | CaO | Al₂O₃ | B₂O₃ | SiO₂ | Content | Alumina | Forsterite | Quartz | Content |
| Number | (wt %) | (wt %) | (wt %) | (wt %) | (wt %) | (wt %) | (wt %) | (wt %) | (wt %) |
| *1 | 33 | 6 | 12 | 49 | 60 | 10 | 10 | 20 | 40 |
| 2 | 35 | 6 | 12 | 47 | 60 | 0 | 20 | 20 | 40 |
| 3 | 50 | 5 | 9 | 36 | 60 | 20 | 0 | 20 | 40 |
| *4 | 52 | 4 | 9 | 35 | 60 | 40 | 0 | 0 | 40 |
| 5 | 47 | 0 | 11 | 42 | 60 | 20 | 20 | 0 | 40 |
| 6 | 38 | 20 | 8 | 34 | 60 | 0 | 0 | 40 | 40 |
| *7 | 37 | 22 | 8 | 33 | 60 | 0 | 40 | 0 | 40 |
| *8 | 49 | 5 | 3 | 43 | 60 | 0 | 0 | 40 | 40 |
| 9 | 48 | 5 | 5 | 42 | 60 | 0 | 40 | 0 | 40 |
| 10 | 40 | 4 | 20 | 36 | 60 | 40 | 0 | 0 | 40 |
| *11 | 39 | 4 | 22 | 35 | 60 | 20 | 20 | 0 | 40 |
| *12 | 48 | 8 | 16 | 28 | 60 | 20 | 0 | 20 | 40 |
| 13 | 48 | 7 | 15 | 30 | 60 | 10 | 10 | 20 | 40 |
| 14 | 38 | 4 | 8 | 50 | 60 | 10 | 20 | 10 | 40 |
| *15 | 37 | 4 | 7 | 52 | 60 | 0 | 20 | 20 | 40 |
| *16 | 45 | 5 | 10 | 40 | 35 | 30 | 20 | 15 | 65 |
| 17 | 45 | 5 | 10 | 40 | 40 | 25 | 20 | 15 | 60 |
| 18 | 45 | 5 | 10 | 40 | 80 | 0 | 0 | 20 | 20 |
| *19 | 45 | 5 | 10 | 40 | 85 | 0 | 5 | 10 | 15 |
| 20 | 45 | 5 | 10 | 40 | 60 | 10 | 10 | 20 | 40 |

### (2) Preparation of Magnetic Ceramic Green Sheet:

A calcined powder of Ni—Cu—Zn based ferrite is mixed with the addition of a solvent, a binder, and a plasticizer thereto to form a slurry, and a doctor blade method was applied thereto to obtain magnetic ceramic green sheets.

These dielectric ceramic green sheets and magnetic ceramic green sheets were used to make the following evaluations.

### (3) Insulation Resistance:

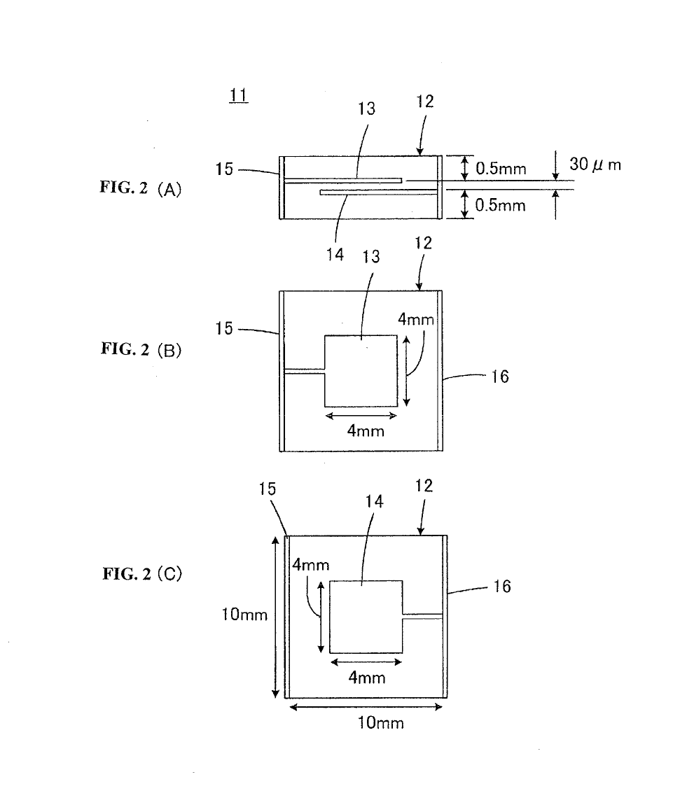

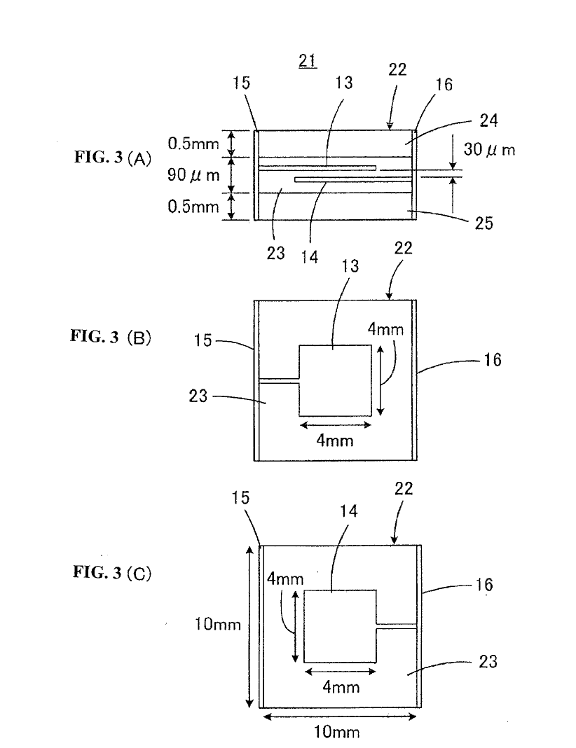

For measurement of insulation resistance, capacitors 11 and 21 were prepared respectively as shown in FIGS. 2 and 3.

### Configuration Common to Capacitors 11 and 21

The capacitors 11 and 21 respectively include substrates 12 and 22. Elements common to the capacitors 11 and 21 are assigned the same reference symbols. Internal electrodes 13 and 14 opposed to each other are arranged within each of the substrates 12 and 22. External electrodes 15 and 16 electrically connected respectively to the internal electrodes 13 and 14 are formed on respective end surfaces opposed to each other for each of the substrates 12 and 22.

The internal electrodes 13 and 14 in FIGS. 2 and 3 are 4 mm×4 mm in planar dimension, and the distance between the internal electrodes 13 and 14 was 30 μm.

For the formation of the internal electrodes 13 and 14, an Ag based paste was used. In addition, in order to obtain the substrates 12 and 22, a firing temperature of 1000° C. or lower was applied.

Configuration specific to Capacitor 11

The capacitor 11 shown in FIG. 2 has the substrate 12 of 10 mm×10 mm×about 1.0 mm (thickness) in dimensions, which is obtained by firing a stacked body of dielectric ceramic green sheets. The internal electrodes 13 and 14 were arranged in the center in the thickness direction of the substrate 12.

### Configuration Specific to Capacitor 21

The capacitor 21 shown in FIG. 3 has the substrate 22 of 10 mm×10 mm×about 1.0 mm (thickness) in dimensions, which is a composite substrate obtained by firing a stacked body of a dielectric ceramic green sheet and a magnetic ceramic green sheet. More specifically, the composite substrate 22 has, as shown in FIG. 3, a stacked structure of a ceramic dielectric layer 23 of 90 μm in thickness sandwiched between two ceramic magnetic layers 24 and 25 each of 0.5 mm in thickness, and internal electrodes 13 and 14 arranged in the center in the thickness direction of the ceramic dielectric layer 23.

### Measurement of Insulation Resistance

For the capacitors 11 and 21, the value of insulation resistance (Ω) was measured with an insulation resistance measuring instrument. The results are shown as log IR in the respective columns of “log IR” in “Single Dielectric Body” and of “log IR” in “Co-sintered Body” in Table 2. In Table 2, the “Single Dielectric Body” corresponds to the capacitor 11, and the “Co-sintered Body” corresponds to the capacitor 21.

### (4) Crystalline Phase:

A predetermined number of only the dielectric ceramic green sheets was stacked, then subjected to pressure bonding and firing to prepare a substrate of 20 mm×20 mm×1.0 mm (thickness). Then, this fired substrate was subjected to grinding in a mortar, and the obtained powder was subjected to an X-ray diffraction analysis, thereby identifying crystalline phases. The results are shown in the column of “Crystalline Phase” in “Single Dielectric Body” in Table 2.

In regard to the “Crystalline Phase” in Table 2, “A” denotes α-alumina, “W” denotes wollastonite, “F” denotes forsterite, and “Q” denotes quartz (quartz). It is to be noted that the crystalline phases “A”, “F”, and “Q” were added as raw materials, as can be seen from species of ceramics listed in the column of “filler” in Table 1, but not crystals deposited during firing.

TABLE 2

| | Single Dielectric Body | | Co-sintered |
|---|---|---|---|
| Sample | Crystalline | | Body |
| Number | Phase | logIR | logIR |
| *1 | A, F, Q | 11.2 | 5.7 |
| 2 | W, F, Q | 11.3 | 11.4 |
| 3 | W, A, Q | 11 | 11 |
| *4 | W, A, Q | 10.8 | 6.3 |
| 5 | W, A, F | 11.3 | 11.2 |
| 6 | W, Q | 11.1 | 11 |
| *7 | Unfired | | — |
| *8 | Unfired | | — |
| 9 | W, F, Q | 11.4 | 11.5 |
| 10 | W, A | 11.1 | 11.2 |
| *11 | A, F | 11 | 4.5 |
| *12 | A, Q | 10.8 | 5.5 |
| 13 | W, A, F, Q | 10.9 | 11 |
| 14 | W, A, F, Q | 11.8 | 11.7 |
| *15 | Unfired | | — |
| *16 | Unfired | | — |
| 17 | W, A, F, Q | 11.9 | 11.8 |
| 18 | W, Q | 10.6 | 10.9 |
| *19 | W, F, Q | 10.4 | 6.1 |
| 20 | W, A, F, Q | 11.8 | 11.6 |

“Crystalline Phase”
A: α-alumina
W: wollastonite
F: forsterite
Q: quartz

In Tables 1 and 2, the sample numbers marked with * refer to comparative examples outside the scope of this invention.

Samples 2, 3, 5, 6, 9, 10, 13, 14, 17, 18, and 20 within the scope of this invention have “W” (wollastonite) deposited within the “Crystalline Phase”, and meet log IR>10 without much of a difference between the “log IR” in the “Co-sintered Body” and “log IR” in the “Single Dielectric Body”.

In contrast, Sample 1 outside the scope of this invention has no “W” (wollastonite) deposited because there was too little CaO in the glass. Therefore, the glass constituent was diffused into the ceramic magnetic layer to significantly decrease the “log IR” in the “Co-sintered Body” as compared with the “log IR” in the “Single Dielectric Body”.

Sample 4 has “W” (wollastonite) deposited, but because there was too much CaO in the glass, the viscosity of the glass was decreased result in diffusion of the glass constituent into the ceramic magnetic layer, thereby significantly decreasing the “log IR” in the “Co-sintered Body” as compared with the “log IR” in the “Single Dielectric Body”. The CaO is a glass modifier oxide, which has the nature of decreasing the viscosity of the glass.

Sample 7 was “Unfired”, i.e., |insufficiently |[M2]sintered because of too much Al₂O₃ in the glass.

Sample 8 was “Unfired”, because of too little B₂O₃ in the glass.

Sample 11 has no “W” (wollastonite) deposited, because there was too much B₂O₃ in the glass. Therefore, the glass constituent was diffused into the ceramic magnetic layer to significantly decrease the “log IR” in the “Co-sintered Body” as compared with the “log IR” in the “Single Dielectric Body”.

Sample 12 has no “W” (wollastonite) deposited, because there was too little SiO₂ in the glass. Therefore, the glass constituent was diffused into the ceramic magnetic layer to significantly decrease the “log IR” in the “Co-sintered Body” as compared with the “log IR” in the “Single Dielectric Body”.

Sample 15 was “Unfired”, because of too much SiO₂ in the glass.

Sample 16 was “Unfired”, because of the too low glass content.

Sample 19 has “W” (wollastonite) deposited, but because of the glass content was too high, the wollastonite failed to suppress the decrease in glass viscosity and there was diffusion of the glass constituent into the ceramic magnetic layer, thereby significantly decreasing the “log IR” in the “Co-sintered Body” as compared with the “log IR” in the “Single Dielectric Body”.

### EXPLANATION OF SYMBOLS

1 ceramic electronic component
2 ceramic dielectric layer
3 ceramic magnetic layer
4 composite substrate

What is claimed is:

1. A ceramic electronic component comprising a composite substrate having stacked ceramic dielectric and ceramic magnetic layers,
wherein the ceramic dielectric layer comprises:
40 to 80% by weight of glass formed from 35 to 50% by weight of CaO, 0 to 20% by weight of Al₂O₃, 5 to 20% by weight of B₂O₃, and 30 to 50% by weight of SiO₂;
20 to 60% by weight of at least one ceramic selected from the group of alumina, forsterite, and quartz; and
further comprising crystalline wollastonite.

2. The ceramic electronic component according to claim 1, wherein the ceramic magnetic layer comprises a Zn-containing ferrite.

3. The ceramic electronic component according to claim 1, wherein the ceramic magnetic layer comprises a Ni—Cu—Zn ferrite.

4. The ceramic electronic component according to claim 3, wherein the glass is formed from 38 to 48% by weight of CaO, 4 to 8% by weight of Al₂O₃, 7 to 15% by weight of B₂O₃, and 34 to 47% by weight of SiO₂.

5. The ceramic electronic component according to claim 4, wherein said ceramic is only one member of said group.

6. The ceramic electronic component according to claim 4, wherein said ceramic is two members of said group.

7. The ceramic electronic component according to claim 4, wherein said ceramic is all three members of said group.

8. The ceramic electronic component according to claim 1, wherein the glass is formed from 38 to 48% by weight of CaO, 4 to 8% by weight of Al₂O₃, 7 to 15% by weight of B₂O₃, and 34 to 47% by weight of SiO₂.

9. The ceramic electronic component according to claim 1, wherein said ceramic is only one member of said group.

10. The ceramic electronic component according to claim 1, wherein said ceramic is two members of said group.

11. The ceramic electronic component according to claim 1, wherein said ceramic is all three members of said group.

12. A method for manufacturing a ceramic electronic component comprising:
providing a composite stacked body comprising a stacked of a dielectric ceramic green sheet and a magnetic ceramic green sheet; and
firing the composite stacked body,
wherein the dielectric ceramic green sheet comprises a fired composition comprising 40 to 80% by weight of glass comprising 35 to 50% by weight of CaO, 0 to 20% by weight of Al₂O₃, 5 to 20% by weight of B₂O₃, and 30 to 50% by weight of SiO₂; and 20 to 60% by weight of at least one ceramic selected from the group of alumina, forsterite, and quartz, and said glass being partially crystallized during firing so as to deposit wollastonite therein.

13. The method for manufacturing a ceramic electronic component according to claim 12 further comprising providing a dielectric ceramic green sheet and a magnetic ceramic green sheet, and forming said a composite stacked body.

14. The method for manufacturing a ceramic electronic component according to claim 12, wherein the ceramic magnetic green sheet comprises a Zn-containing ferrite.

15. The method for manufacturing a ceramic electronic component according to claim 12, wherein the ceramic magnetic green sheet comprises a Ni—Cu—Zn ferrite.

16. The method for manufacturing a ceramic electronic component according to claim 12, wherein the glass is formed from 38 to 48% by weight of CaO, 4 to 8% by weight of Al₂O₃, 7 to 15% by weight of B₂O₃, and 34 to 47% by weight of SiO₂.

17. The method for manufacturing a ceramic electronic component according to claim 12, wherein said ceramic is only one member of said group.

18. The method for manufacturing a ceramic electronic component according to claim 12, wherein said ceramic is two members of said group.

19. The method for manufacturing a ceramic electronic component according to claim 12, wherein said ceramic is all three members of said group.

20. The method for manufacturing a ceramic electronic component according to claim 12, wherein the dielectric ceramic green sheet and magnetic ceramic green sheet each comprise a plurality of layers.
